(19) United States
(12) Patent Application Publication
(10) Pub. No.: US 2012/0303689 A1
(43) Pub. Date: Nov. 29, 2012

(54) ARITHMETIC CIRCUIT AND A/D CONVERTER

(75) Inventors: Masanori FURUTA, Odawara-shi (JP); Hirotomo ISHII, Kamakura-shi (JP)

(73) Assignee: KABUSHIKI KAISHA TOSHIBA, Tokyo (JP)

(21) Appl. No.: 13/426,528

(22) Filed: Mar. 21, 2012

(30) Foreign Application Priority Data
May 27, 2011 (JP) 2011-119071

(51) Int. Cl. G06G 7/00

(52) U.S. Cl. 708/200; 708/801

(57) ABSTRACT

An arithmetic circuit includes: an input terminal for receiving an input signal; plural capacitors; and an amplifier circuit including an amplifying input terminal and an output terminal and configured to amplify a signal input from the amplifying input terminal and output it as an output signal from the output terminal. A first switch circuit becomes conductive based on a first control signal and connects the plural capacitors in parallel between the input terminal and a first voltage terminal for supplying a first voltage. A second switch circuit becomes conductive based on a second control signal and connects a first capacitor of the plural capacitors between the amplifying input terminal and a second voltage terminal for supplying a second voltage to form a first current path and a second capacitor of the plural capacitors between the amplifying input terminal and the output terminal to form a second current path.

### CROSS REFERENCE TO RELATED APPLICATIONS

This application is based on and claims the benefit of priority from prior Japanese Patent Application No. 2011-119071, filed on May 27, 2011, the entire contents of which are incorporated herein by reference.

### FIELD

Embodiments described herein relate generally to an arithmetic circuit and an A/D converter using the same.

### BACKGROUND

An arithmetic circuit configured to amplify an analog signal by a desired amplification factor to output an amplified signal is used in an electronic circuit such as a pipelined A/D converter, etc. for amplifying a residual signal, etc. It is expected of such an arithmetic circuit to secure a necessary bandwidth and achieve a desired gain at the same time.

### BRIEF DESCRIPTION OF THE DRAWINGS

FIG. 1 is an equivalent circuit schematic showing a configuration of an arithmetic circuit according to a first embodiment.

FIG. 2 is an equivalent circuit schematic showing a configuration of an arithmetic circuit according to the first embodiment.

FIG. 3 explains a mechanism of an arithmetic circuit according to the first embodiment.

FIG. 4A explains a mechanism of an arithmetic circuit according to the first embodiment

FIG. 4B explains a mechanism of an arithmetic circuit according to the first embodiment.

FIG. 5 an equivalent circuit schematic showing a configuration of an arithmetic circuit according to a modification of the first embodiment.

FIG. 6 is an equivalent circuit schematic showing a configuration of an arithmetic circuit according to a modification of the first embodiment.

FIG. 7 is an equivalent circuit schematic showing a configuration of an arithmetic circuit according to a second embodiment.

FIG. 8 is an equivalent circuit schematic showing a configuration of an arithmetic circuit according to the second embodiment.

FIG. 9A explains a mechanism of an arithmetic circuit according to the second embodiment.

FIG. 9B explains a mechanism of an arithmetic circuit according to the second embodiment.

FIG. 10 is an equivalent circuit schematic showing a configuration of an arithmetic circuit according to a third embodiment.

FIG. 11 is an equivalent circuit schematic showing a configuration of an arithmetic circuit according to a fourth embodiment.

FIG. 12A explains a mechanism of an arithmetic circuit according to the fourth embodiment.

FIG. 12B explains a mechanism of an arithmetic circuit according to the fourth embodiment.

FIG. 13 is a block diagram explaining a configuration of a pipelined A/D converter.

FIG. 14 is a schematic diagram showing a configuration of a pipelined A/D converter.

FIG. 15 shows an operation of a pipelined A/D converter.

FIG. 16 shows an operation of a pipelined A/D converter.

### DETAILED DESCRIPTION

An arithmetic circuit according to the embodiments explained below includes: an input terminal configured to receive an input signal; a plurality of capacitors; and an amplifier circuit including an amplifying input terminal and an output terminal and configured to amplify a signal input from the amplifying input terminal and output it as an output signal from the output terminal. A first switch circuit becomes conductive based on a first control signal and thereby connects the plurality of capacitors in parallel between the input terminal and a first voltage terminal for supplying a first voltage. A second switch circuit becomes conductive based on a second control signal and thereby connects a first capacitor of the plurality of capacitors between the amplifying input terminal and a second voltage terminal for supplying a second voltage so as to form a first current path, and connects a second capacitor of the plurality of capacitors between the amplifying input terminal and the output terminal so as to form a second current path.

The embodiments of the present invention will now be explained with reference to the drawings.

### First Embodiment

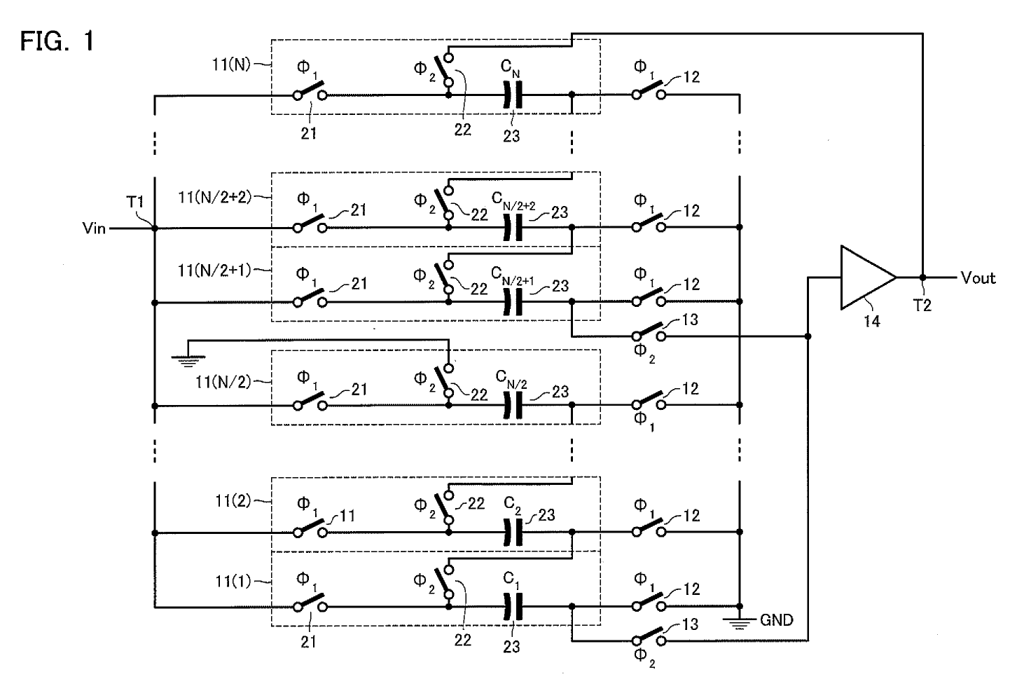

FIG. 1 is an equivalent circuit schematic showing a configuration of an arithmetic circuit according to the first embodiment. The arithmetic circuit includes a plurality (N) of capacitor circuits 11(1) to 11(N) (N being an even number equal to or larger than 2), switches 12, switches 13, and an amplifier 14. The amplifier 14 may be an inverting amplifier with a negative feedback path. The arithmetic circuit includes an input terminal T1 for receiving an input signal Vin, and an output terminal T2 of the amplifier 14. The arithmetic circuit according to the present embodiment allows for amplifying an input signal Vin by connecting the capacitors included in the capacitor circuits 11(1) to 11(N) in parallel with one another to charge them up to a certain voltage, and after this, switching them to be connected in cascade with one another.

Each of the capacitor circuits 11(1) to 11(N) includes a parallel connection switch 21, a cascade connection switch 22, and a capacitor 23 (capacitance Cᵢ (i=1 to N)).

The parallel connection switch 21 is connected between the input terminal T1 and a lower electrode (bottom plate) of the capacitor 23.

The parallel connection switch 21 is configured to be capable of being switched between a conductive state and a nonconductive state in accordance with a control signal Φ₁ (here, the explanation will be given on the assumption that Φ₁=“1” causes switching to a conductive state and Φ₁=“0” causes switching to a nonconductive state).

The cascade connection switch 22 is connected between the lower electrode of the capacitor 23 in the capacitor circuit 11(i) and an upper electrode (top plate) of the capacitor 23 in the adjoining capacitor circuit 11(i+1). However, the cascade connection switch 22 in the N-th capacitor circuit 11(N) is connected between the lower electrode in the capacitor circuit 11(N) and the output terminal T2 of the amplifier 14. The two electrodes of the capacitor 23 are referred to as “upper electrode” and “lower electrode” respectively, but these address terms are for the convenience of explanation only, and not meant to limit the directions of the capacitor 23. The present embodiment can also be applied to a circuit in which one electrode and the other electrode are arranged side by side horizontally, or to a circuit in which the electrodes are interchanged vertically.

One end of the cascade connection switch 22 of the N/2-th capacitor circuit 11(N/2) is connected to a grounding terminal, and not to the adjoining capacitor circuit 11(N/2+1). Thereby, the cascade connection switch 22 is switched between a conductive state and a nonconductive state in accordance with a control signal Φ₂ (here, Φ₂=“1” causes switching to a conductive state, and Φ₂=“0” causes switching to a nonconductive state). The grounding terminal may be replaced by a certain voltage terminal supplying a certain voltage. The same holds true in the following descriptions.

The switches 12 described above are connected between the upper electrodes of the capacitors 23 and a grounding terminal (fixed voltage terminal). The switches 12 are switched between a conductive state and a nonconductive state in accordance with the control signal Φ₁. The switches 12 and the parallel connection switches 21 are both switched to a conductive state in accordance with the control signal Φ₁, and function as a first switch circuit configured to connect the N number of capacitors 23 in parallel between the input terminal T1 and the grounding terminal GND. Modification for connecting the capacitors 23 to a voltage terminal supplied with any voltage instead of the grounding terminal GND may also be possible.

The upper electrodes of the capacitors 23 of the capacitor circuits 11(1) and 11(N/2+1) are connected to an input terminal (amplifying input terminal) of the amplifier 14 through the switches 13 which are switched to a conductive state in accordance with the control signal Φ₂. As the case may be, the switches 13 may be omitted, and the capacitors 23 (C₁, C_{N/2+1}) and the input terminal of the amplifier 14 may be short-circuited. The switches 13 and the cascade connection switches 22 both become a conductive state in accordance with the control signal Φ₂. The switches 13 and the cascade connection switches 22 function as a second switch circuit configured to connect some of the N number of capacitors 23, e.g., N/2 number of capacitors 23 in series between the input terminal of the amplifier 14 and the grounding terminal GND, and connect some of the N number of capacitors 23, e.g., the remaining N/2 number of capacitors 23 in series between the input terminal and output terminal T2 of the amplifier 14.

In the example of FIG. 1, half of the N number of capacitors 23, i.e., N/2 number of capacitors 23 are connected in series between the grounding terminal and the input terminal of the amplifier 14, and the remaining half, i.e., N/2 number of capacitors 23 are connected in series between the input terminal and output terminal T2 of the amplifier 14. However, both of the groups need not include the same number of capacitors, and hence the former group may include a larger number of capacitors than those included in the latter group, and vice versa. Furthermore, one group may include a single capacitor. Moreover, all of the capacitors 23 need not have the same capacitance.

The switch 12 configured to be switched between a conductive state and a nonconductive state in accordance with the control signal Φ₁ is connected between the upper electrode of the capacitor 23 and the grounding terminal GND (fixed voltage terminal).

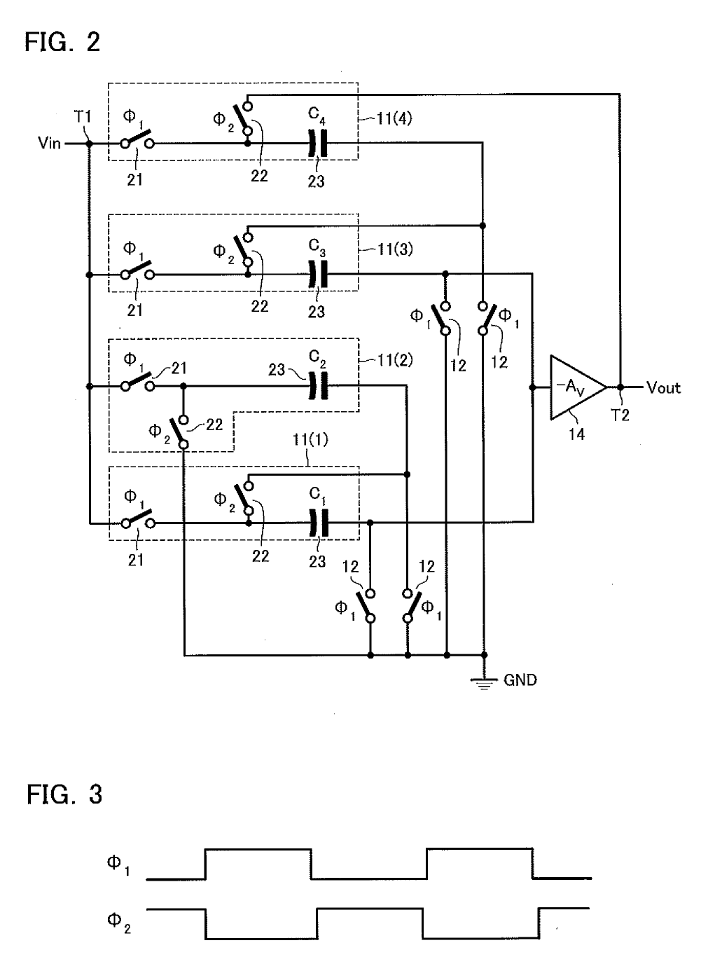

FIG. 2 shows an equivalent circuit schematic for N=4. The control signals Φ₁ and Φ₂ are exclusive clock signals, and hence one of them is “1” when the other of them is “0”, as shown in FIG. 3. Note that there may be time periods when both the control signals Φ₁ and Φ₂ become “0” at the same time.

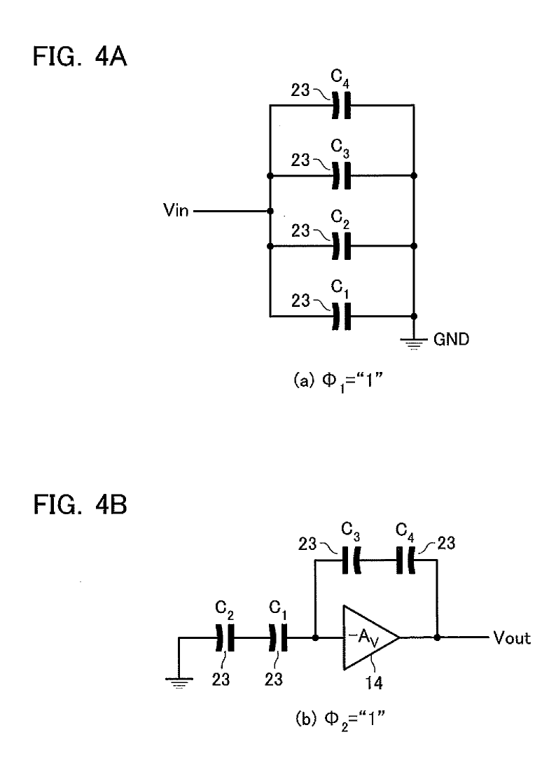

Next, an operation of the arithmetic circuit according to the present embodiment will be explained. Here, explanation will be given for the case of N=4 (FIG. 2) for simplification of the explanation. When the control signal Φ₁ becomes “1” at a certain timing, the four capacitors 23 (C₁ to C₄) become connected in parallel between the input terminal T1 (=the terminal supplied with the input signal Vin) and the grounding terminal GND such that the lower electrodes are on the side of the input terminal T1 as shown in FIG. 4A, and are charged up to the same voltage Vin.

After this, after the control signal Φ₁ returns to “0” again, the control signal Φ₂ changes from “0” to “1”. In response, the capacitors C₁ to C₂ become connected in series between the grounding terminal and the amplifier 14 such that their lower electrodes are on the side of the grounding terminal as shown in FIG. 4B. Thereby, the capacitors C₁ to C₂ give a voltage 2×Vin to the input terminal of the amplifier 14.

On the other hand, the capacitors C₃ to C₄ become connected in series between the input terminal and output terminal of the amplifier 14 such that their lower electrodes are on the side of the output terminal of the amplifier 14, as shown in FIG. 4B. These capacitors C₃ to C₄ constitute a negative feedback loop for the amplifier 14.

The output signal (Vout) of the amplifier 14 at the moment is expressed by the following equation, provided that C₁=C₂=C₃=C₄.

$$Vout = \frac{4 Vin}{1 - 2 / Av} \qquad [ Equation 1 ]$$

When the amplification factor Av of the amplifier 14 is by far larger than 1 (Av>>1), the result becomes Vout≈4Vin, which means that the arithmetic circuit of FIG. 2 has an amplification factor of 4 times. When there are N number of capacitors as shown in FIG. 1, the amplification factor is N times. In this way, the behavior of the control signal Φ₂ to switch to “1” causes the input signal Vin to be amplified by N times.

When C₁=C₂=C₃=C₄=C, the ratio between a feedback capacitance Cf (═C₃·C₄/(C₃+C₄)) and an input capacitance Ci (=C₁·C₂/(C₁+C₂)) becomes 1. A conventional switched-capacitor negative-feedback amplifier circuit can increase the amplification factor of the arithmetic circuit by increasing the ratio between the feedback capacitance Cf and the input capacitance Ci, but has a problem that it cannot increase the amplification factor without reducing the bandwidth instead.

However, according to the present embodiment, it is possible to prescribe the amplification factor by the number N of the capacitors 23, while it is also possible to keep the bandwidth constant unless the ratio between the feedback capacitance Cf and the input capacitance Ci is changed. Therefore, it is possible to secure a desired bandwidth and achieve a desired amplification factor at the same time.

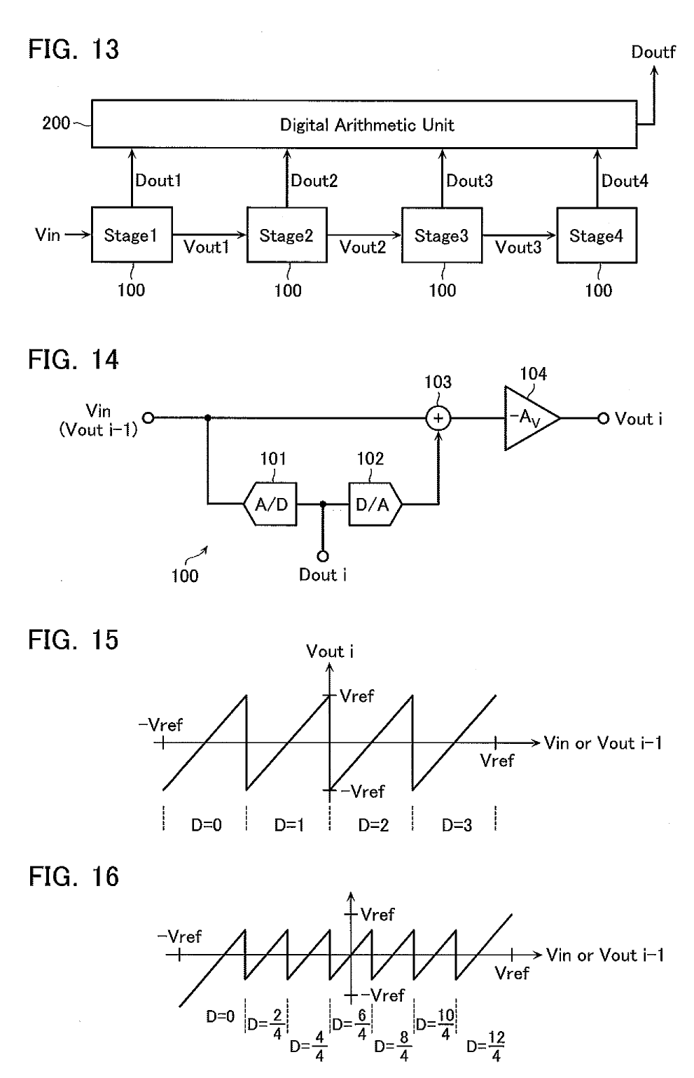

The arithmetic circuit of FIG. 1 can be used, for example, as an arithmetic circuit used in a pipelined A/D converter shown in FIG. 13 and FIG. 14. The configuration of this pipelined A/D converter will be explained with reference to FIG. 13.

The pipelined A/D converter includes a plurality of stages 100 connected in cascade, and a digital arithmetic unit 200. Each stage 100 converts an analog input signal Vin input from outside or an analog input signal Vouti−1 (i=1 to 3) output by the preceding stage 100 to a digital signal Douti and outputs it to the digital arithmetic unit 200. Each stage 100 also reconverts the digital signal Douti to an analog signal, subtracts this analog signal from the input analog signal Vin or Vouti−1, amplifies an analog signal resulting from the subtraction by a certain amplification factor, and supplies it to the succeeding stage 100. Hence, the input signal Vin is converted to a digital signal of a few bits based on the plurality of digital signals Dout1 to Dout4 obtained in this way.

FIG. 14 shows the configuration of each stage 100. Each stage 100 includes an A/D converter circuit 101, a D/A converter circuit 102, a subtractor 103, and an amplifying arithmetic circuit 104. The arithmetic circuit according to the first embodiment can be used as the amplifying arithmetic circuit 104. The A/D converter circuit 101 converts an input analog signal Vin or Vouti−1 to a digital signal Di. This digital signal Di is output to the digital arithmetic unit 200, and also reconverted to an analog signal by the D/A converter circuit 102 and input into the subtractor 103. The subtractor 103 subtracts the analog signal output by the D/A converter circuit 102 from the input analog signal Vin or Vouti−1. The amplifying arithmetic circuit 104 amplifies the analog signal resulting from the subtraction by a certain amplification factor and outputs it as an output signal Vouti.

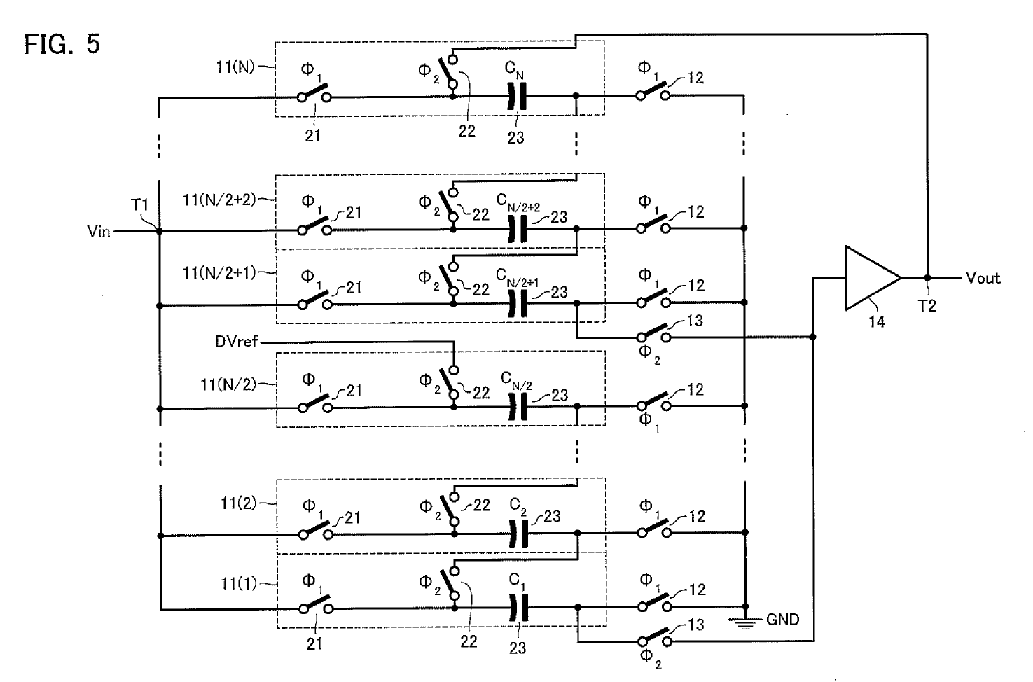

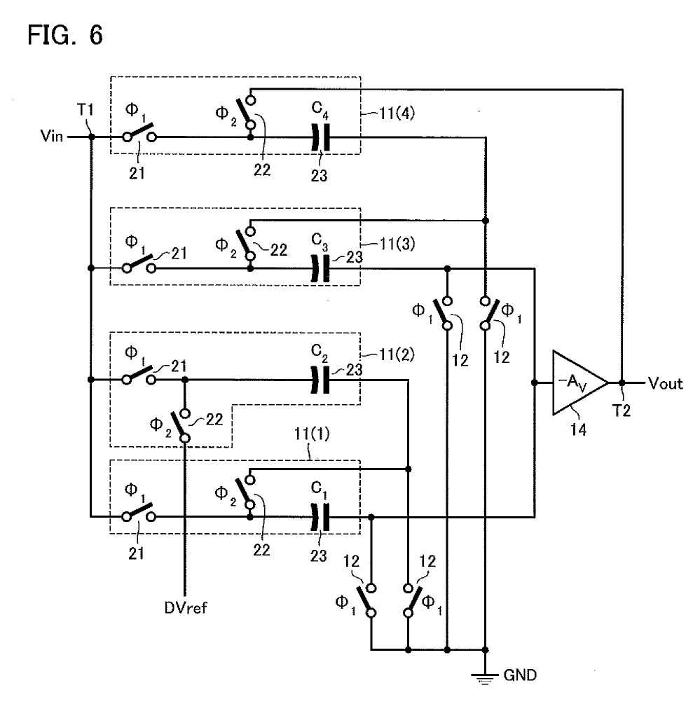

FIG. 5 shows a modification example of the first embodiment. This modification example is different from the first embodiment in that a voltage D·Vref having a value obtained by multiplying a reference voltage Vref by a digital value D is applied to the other end of the cascade connection switch 22 of the capacitor circuit 11(N/2). FIG. 6 shows a circuit configuration for when N=4 in FIG. 5.

Here, the reference voltage Vref is a voltage used by the A/D converter circuit 101 when the arithmetic circuit of FIG. 5 is used in such a pipelined A/D converter as shown in FIG. 13 and FIG. 14. The digital value D is the digital signal Di output by the A/D converter circuit 101. With such a voltage D·Vref applied to the other end of the cascade connection switch 22, a signal obtained by subtracting the voltage D·Vref is amplified by the arithmetic circuit of FIG. 5.

The digital value D varies according to a digital signal of how many bits is to be generated by the A/D converter circuit 101 of each stage 100. FIG. 15 shows the transfer characteristic of each stage 100 for when the A/D converter circuit 101 of each stage 100 is supposed to perform A/D conversion for outputting a digital signal of 2 bits (2 bits/stage). FIG. 16 shows a transfer characteristic for when the A/D converter circuit 101 of each stage 100 employs a 2.5 bits/stage scheme. The 2.5 bits/stage scheme is for generating a digital signal of 3 bits (8 values) but using part of the signal as error correction signal. FIG. 16 shows an example where seven values out of the eight-value signal are used as digital signal.

The output signal Vout of the arithmetic circuit of FIG. 5 has the following value, provided that the amplification factor of the amplifier is Av when N=4.

$$Vout = \frac{4 Vin - D \cdot Vref}{1 - 2 / Av} \qquad [ Equation 2 ]$$

When the amplification factor Av is a value that is by far larger than 1, the output voltage can be expressed as Vout≈4Vin−D·Vref, and hence it is possible to achieve any amplification factor in accordance with the number N of capacitors 23, regardless of any fluctuation in the amplification factor of the amplifier 14. Moreover, it is possible to keep the bandwidth constant unless the ratio between the feedback capacitance Cf and the input capacitance Ci is changed. That is, it is possible to set any amplification factor in accordance with the number N of capacitors 23 while keeping the bandwidth constant.

### Second Embodiment

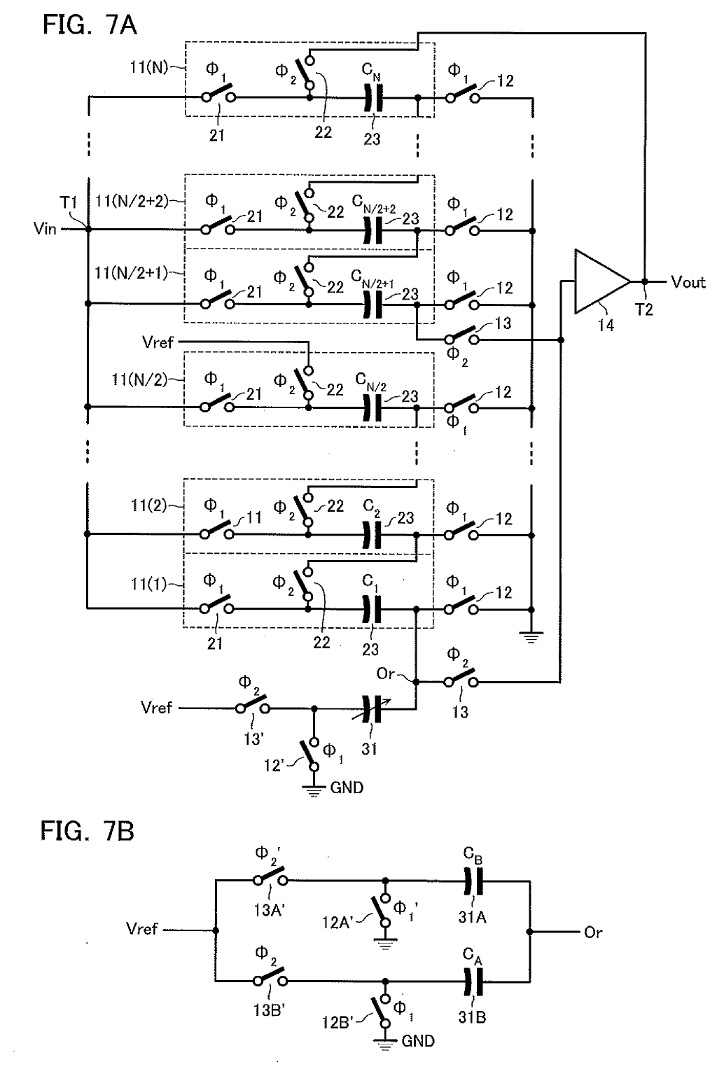

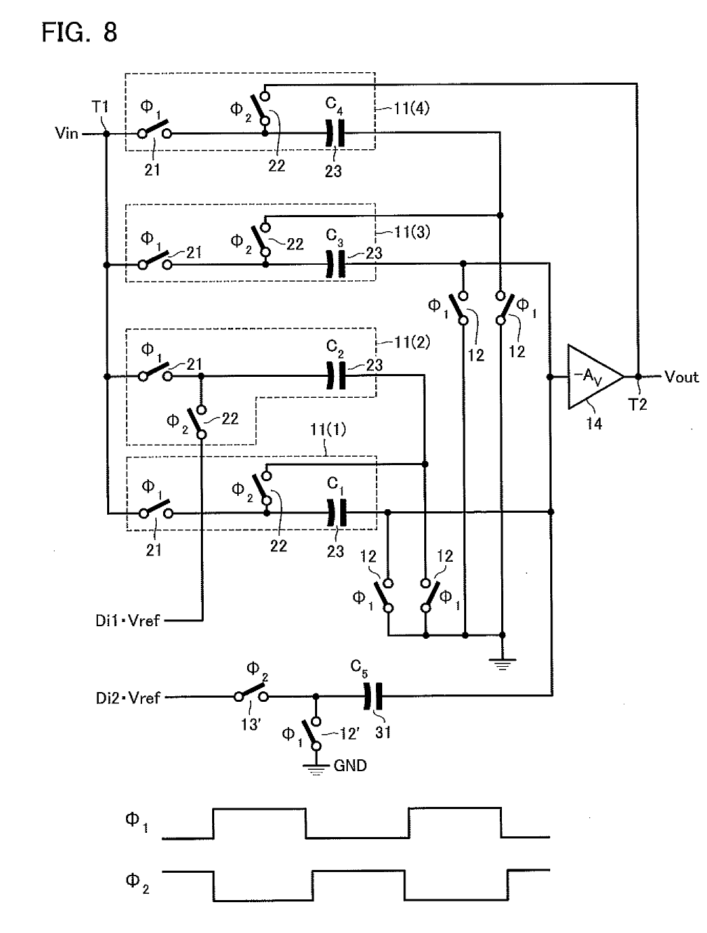

FIG. 7A, FIG. 7B, and FIG. 8 are equivalent circuit schematics showing configurations of arithmetic circuits according to the second embodiment. FIG. 7A shows a circuit configuration including N number of capacitor circuits 11(1) to 11(N) like the first embodiment. FIG. 7B shows a modification example of FIG. 7A. FIG. 8 shows a circuit configuration for N=4. Any components that are the same as the components in FIG. 1 and FIG. 2 will be denoted by the same reference numerals in FIG. 7A, FIG. 7B, and FIG. 8, and a detailed explanation about such components will not be provided below.

As shown in FIG. 7A, the arithmetic circuit according to the second embodiment includes a capacitor 31 and switches 12′ and 13′ in addition to the components of the first embodiment.

The capacitor 31 is a variable capacitor of which capacitance is variable. The upper electrode of the capacitor 31 is configured to be connectable to the input terminal of the amplifier 14 through the switch 13. The lower electrode of the capacitor 31 is configured to be connectable to a grounding terminal through the switch 12′ controlled by the control signal Φ₁, and connectable to a terminal for supplying a reference voltage Vref through the switch 13′ controlled by the control signal Φ₂.

It is also possible to achieve a variable capacitance by, instead of using the variable capacitor 31, providing a plurality of, e.g., two capacitors 31A (capacitance C_{A}) and 31B (capacitance C_{B}) having different capacitances, and making switches 12A′, 12B′, 13A′, and 13B′ conductive selectively, as shown in FIG. 7B.

FIG. 8 shows a circuit configuration for when N=4 in the circuit of FIG. 7. Note that the capacitor 31 is a capacitor having a fixed capacitance. Further note that the signal to be input into one end of the capacitor 23 of the capacitor circuit 11(2) has a voltage value obtained by multiplying the reference voltage Vref by a variable Di1, and the signal to be input into the capacitor 31 has a voltage value obtained by multiplying the reference voltage Vref by a variable Di2.

The variables Di1 and Di2 are determined by the value of an output signal D (FIG. 15) of the case when the arithmetic circuit is used in, for example, a pipelined A/D converter of 2 bits/stage scheme. In this case, the variable Di1 is 1 when the control signal Φ₂ is “1” and the output signal D is 1 or 3. The variable Di1 is 0 otherwise. The variable Di2 is 1 when the control signal Φ₂ is “1” and the output signal D is 1 or 3. The variable Di2 is 0 otherwise.

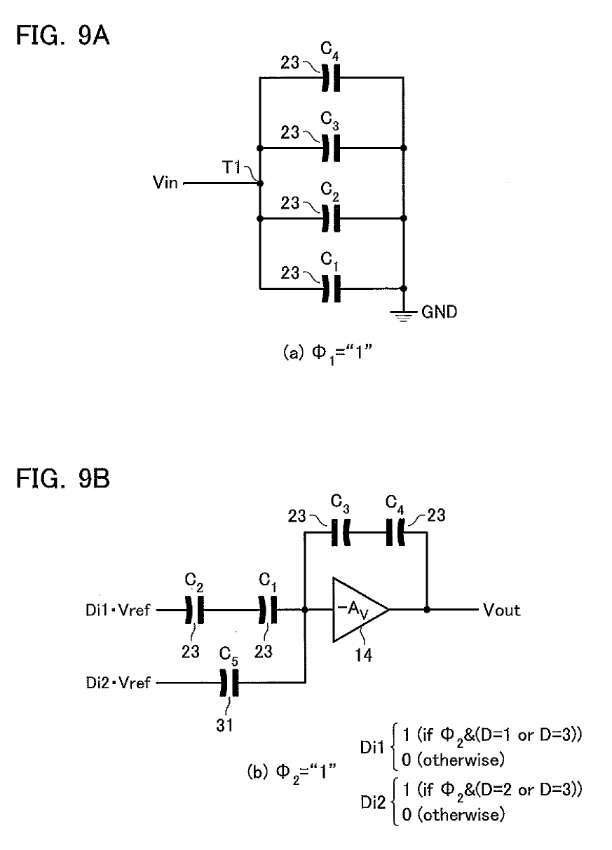

An operation of the arithmetic circuit of FIG. 8 will be explained with reference to FIG. 9A and FIG. 9B. When the control signal Φ₁ is “1”, the four capacitors 23 (C₁ to C₄) become connected in parallel between the input terminal T1 and the grounding terminal as shown in FIG. 9A, in response to the parallel connection switches 21 and the switches 12 becoming conductive.

After this, when the control signal Φ₂ becomes “1”, the four capacitors 23 (C₁ to C₄) become connected in the same way as in the first embodiment (FIG. 4B), and also, one end (upper electrode) of the capacitor 31 becomes connected to the input terminal of the amplifier 14 and the other end (lower electrode) thereof becomes supplied with the signal Di2·Vref described above. One end of the capacitor 23 (capacitance C₂) becomes supplied with the signal Di1·Vref.

When the capacitances C₁, C₂, C₃, C₄, and C₅ of the five capacitors 23 and 31 are all C (C₁=C₂=C₃=C₄=C₅=C), the output voltage (Vout) is expressed as follows, provided that the amplification factor of the amplifier is Av.

$$Vout = \frac{4 Vin - 2 Di 2 \cdot Vref - Di 1 \cdot Vref}{1 - 2 / Av} \qquad [ Equation 3 ]$$

When the amplification factor Av is a value that is by far larger than 1, the output signal Vout can be expressed as Vout≈4Vin−2Di2·Vref−Di1·Vref. It is possible to achieve any amplification factor in accordance with the number N of capacitors 23, regardless of any fluctuation in the amplification factor of the amplifier 14.

As can be understood from [Equation 3] above, by providing the capacitor 31, it becomes possible to output the output voltage Vout as a value obtained by subtracting the product of the reference voltage Vref and the variable Di2×2. That is, the capacitor 31 functions as a reference voltage subtracting circuit configured to provide a signal obtained by subtracting a product of the reference voltage Vref and a variable.

### Third Embodiment

FIG. 10 is an equivalent circuit schematic showing the configuration of an arithmetic circuit according to the third embodiment. Any components that are the same as the components of the second embodiment will be denoted in FIG. 10 by the same reference numerals as used in FIG. 7A, and hence a detailed explanation about such components will not be provided below.

The arithmetic circuit according to the present embodiment is substantially the same as the second embodiment (FIG. 7A) as regards the configuration of the capacitor circuits 11. However, in the present embodiment, the arithmetic circuit includes capacitor circuits 41(1) to 41(M) instead of the capacitor 31. There are provided L number (e.g., L<M) of capacitor circuit groups each constituted by these capacitor circuits 41(1) to 41(M). The capacitor circuits 41(1) to 41(M) function as a reference voltage subtracting circuit like the capacitor 31.

Each capacitor circuit 41(j) (j=1 to M) includes a parallel connection switch 51, a cascade connection switch 52, and a capacitor 53 (capacitance Cⱼ′ (j=1 to M)). Each capacitor circuit 41(j) also includes a switch 12′ between itself and a grounding terminal.

The parallel connection switches 51 become conductive together with the switches 12′ when the control signal Φ₁ becomes “1”, thereby connecting the plurality of capacitors 53 in parallel between the grounding terminal and the terminal for supplying the reference voltage Vref.

The cascade connection switch 52 is configured to be capable of being switched between a conductive state and a nonconductive state in accordance with a control signal Φ₂ (here, the explanation will be given on the assumption that Φ₂=“1” causes switching to a conductive state and Φ₂=“0” causes switching to a nonconductive state). The cascade connection switch 52 is connected between the lower electrode of the capacitor 53 in the capacitor circuit 41(j) and the upper electrode (top plate) of the capacitor 53 in the adjoining capacitor circuit 41(j+1). However, the cascade connection switch 52 in the M-th capacitor circuit 41(M) is connected to a grounding terminal.

There are L number of capacitor circuit groups each constituted by such capacitor circuits 41(1) to 41(M). In the m-th capacitor circuit group (m=1 to L) among the L number of capacitor circuit groups (1) to (L), its (M−m) number of capacitor circuits 41 among its M number of capacitor circuits 41(1) to 41(M) are supplied with the reference voltage Vref at their one end, and its remaining capacitor circuits 41 are supplied with a grounding voltage at their both ends.

By selecting any capacitor circuit group from among the L number of capacitor circuit groups (1) to (L) by switches 42, it is possible to set any subtrahend to be subtracted from the output voltage Vout.

### Fourth Embodiment

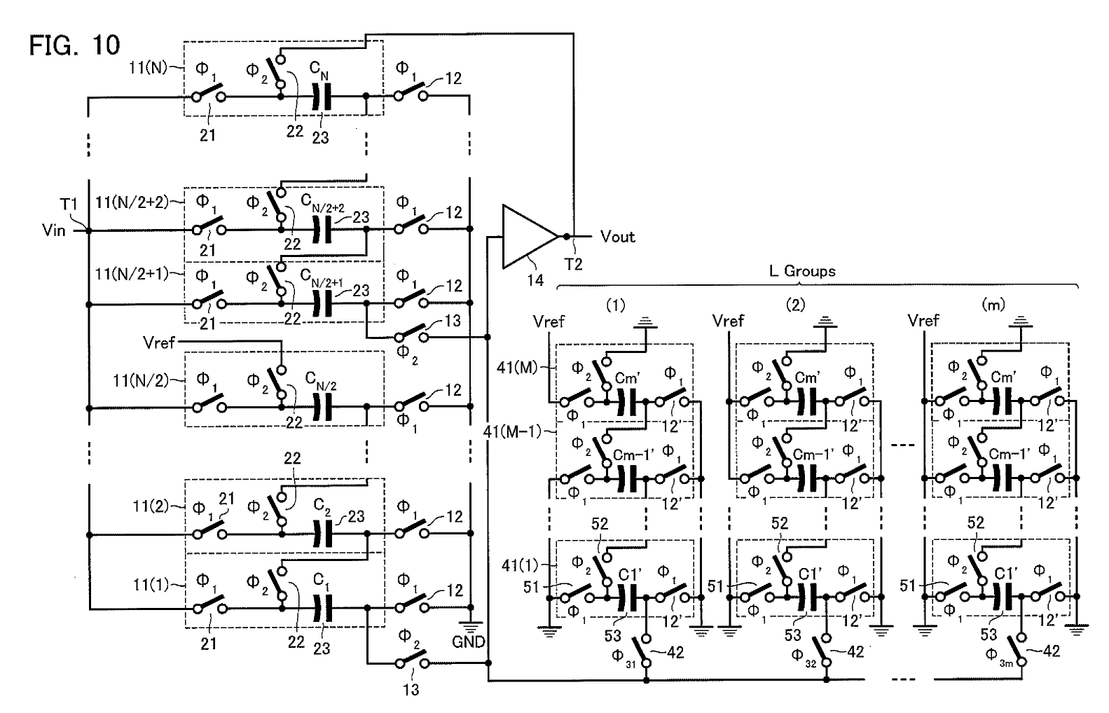

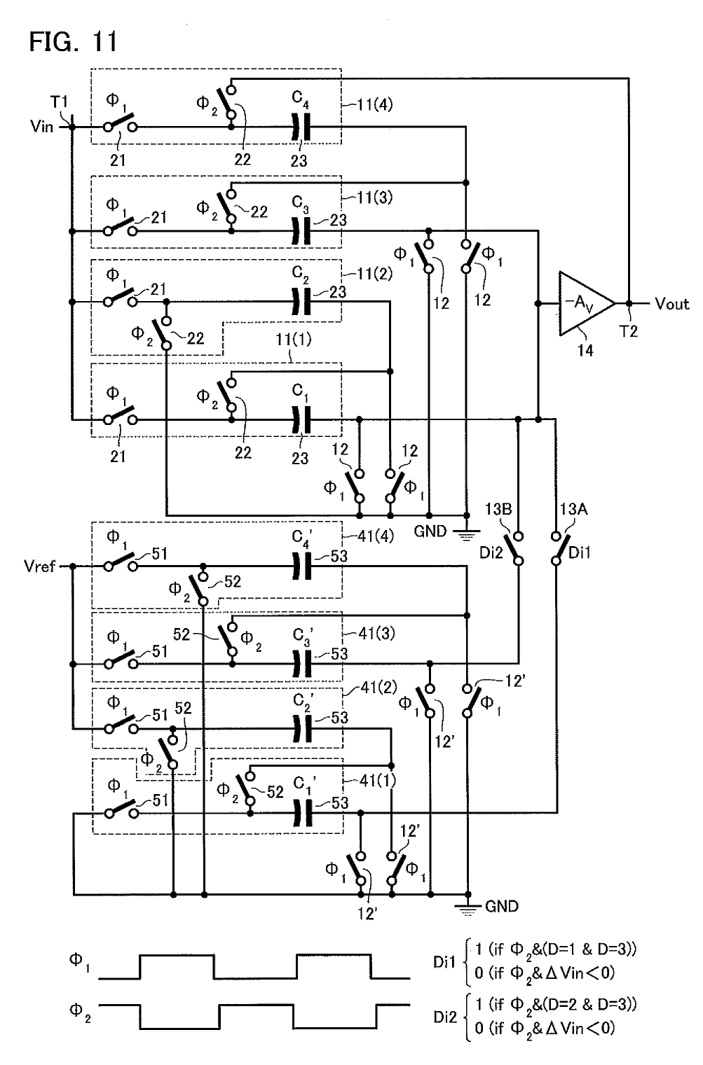

FIG. 11 is an equivalent circuit schematic showing the configuration of an arithmetic circuit according to the fourth embodiment. Any components that are the same as the components of the second embodiment will be denoted in FIG. 11 by the same reference numerals as used in FIG. 8, and hence a detailed explanation about such components will not be provided below.

The present embodiment is substantially the same as the second embodiment (FIG. 8) as regards the configuration of the capacitor circuits 11(1) to 11(4). However, the other end of the cascade connection switch 22 of the capacitor circuit 11(2) is grounded. FIG. 11 shows an example where the number N of capacitor circuits 11 is 4. However, needless to say, the number N may be any number in accordance with the amplification factor required.

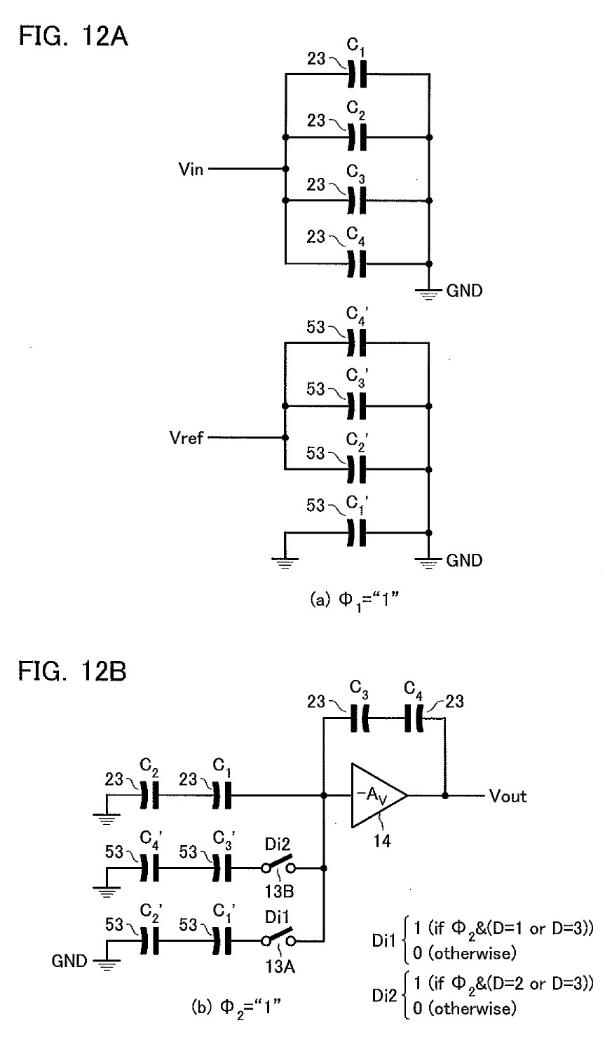

The fourth embodiment is similar to the third embodiment in including capacitor circuits 41(1) to 41(n) functioning as a reference voltage subtracting circuit. In the present embodiment, the capacitor circuits 41(2) to 41(4) are supplied with the reference voltage Vref through the parallel connection switches 51. The capacitors 53 in the capacitor circuits 41(2) to 41(4) become connected in parallel between the terminal supplying the reference voltage Vref and a grounding terminal as shown in FIG. 12A in response to the parallel connection switches 51 and the switches 12′ becoming conductive when the control signal Φ₁ becomes “1”.

On the other hand, the capacitor 53 in the capacitor circuit 41(1) becomes connected to a grounding terminal at both ends as shown in FIG. 12A in response to the parallel connection switch 51 and the switch 12′ becoming conductive when the control signal Φ₁ becomes “1”.

After this, when the control signal Φ₂ becomes “1”, the parallel connection switches 22 and 52 become conductive. In response, the capacitors 23 in the capacitor circuits 11(1) to 11(4) become connected in the same way as in the embodiment described above as shown in FIG. 12B. On the other hand, two capacitors 53 (C₃′, C₄′) in the capacitor circuits 41(3) and 41(4) become connected in series between the input terminal of the amplifier 14 and a grounding terminal through a switch 13B.

Two capacitors 53 (C₁′, C₂′) in the capacitor circuits 41(1) and 41(2) become connected in series between the input terminal of the amplifier 14 and a grounding terminal through a switch 13A.

The switches 13A and 13B are configured to be switched between a conductive state and a nonconductive state in accordance with the variables Di1 and Dig described above. When the control signal Φ₂ is “1” and the output signal D is 1 or 3, the variable Di1 is 1, making the switch 13A conductive. Otherwise, the variable Di1 is 0, making the switch 13A nonconductive.

When the control signal Φ₂ is “1” and the output signal D is 2 or 3, the variable Di2 is 1, making the switch 13B conductive. Otherwise, the variable Di2 is 0, making the switch 13B nonconductive.

According to the present embodiment, it is only necessary to provide one reference voltage Vref, which allows for reducing the circuit area of a reference voltage generating circuit.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An arithmetic circuit, comprising:
an input terminal configured to receive an input signal;
a plurality of capacitors;
an amplifier circuit including an amplifying input terminal and an output terminal, and configured to amplify a signal input from the amplifying input terminal and output it as an output signal from the output terminal;
a first switch circuit configured to become conductive based on a first control signal to thereby connect the plurality of capacitors in parallel between the input terminal and a first voltage terminal for supplying a first voltage; and
a second switch circuit configured to become conductive based on a second control signal to thereby connect a first capacitor of the plurality of capacitors between the amplifying input terminal and a second voltage terminal for supplying a second voltage so as to form a first current path, and connect a second capacitor of the plurality of capacitors between the amplifying input terminal and the output terminal so as to form a second current path.

2. The arithmetic circuit according to claim 1,
wherein a plurality of capacitors are connected in series in at least one of the first current path and the second current path.

3. The arithmetic circuit according to claim 1,
wherein the second voltage has a value obtained by multiplying a variable by a voltage value of a reference voltage.

4. The arithmetic circuit according to claim 3,
wherein the variable is a digital value.

5. The arithmetic circuit according to claim 1, further comprising a third capacitor and a third switch circuit configured to become conductive based on the second control signal,
wherein the third switch circuit connects one end of the third capacitor to the amplifying input terminal and the other end thereof to a third voltage terminal for supplying a third voltage based on the second control signal.

6. The arithmetic circuit according to claim 5,
wherein the first switch circuit connects the other end of the third capacitor to a fourth voltage terminal for supplying a fourth voltage based on the first control signal.

7. The arithmetic circuit according to claim 5,
wherein the second voltage has a value obtained by multiplying a variable by a voltage value of a reference voltage.

8. The arithmetic circuit according to claim 7,
wherein the third voltage has a value obtained by multiplying a variable by a voltage value of a reference voltage.

9. The arithmetic circuit according to claim 6,
wherein the third capacitor is a variable capacitor.

10. The arithmetic circuit according to claim 1, further comprising a plurality of fourth capacitors,
wherein the first switch circuit connects the plurality of fourth capacitors in parallel between a terminal for supplying a reference voltage and the first voltage terminal based on the first control signal, and
the second switch circuit connects the plurality of fourth capacitors in series based on the second control signal.

11. The arithmetic circuit according to claim 1,
wherein the first and second switch circuits becomes conductive alternately.

12. The arithmetic circuit according to claim 11,
wherein a plurality of capacitors are connected in series in at least one of the first current path and the second current path.

13. The arithmetic circuit according to claim 11, further comprising a third capacitor and a third switch circuit configured to become conductive based on the second control signal,
wherein the third switch circuit connects one end of the third capacitor to the amplifying input terminal and the other end thereof to a third voltage terminal for supplying a third voltage based on the second control signal.

14. An A/D converter, comprising: a plurality of stages connected in cascade; and a digital arithmetic unit configured to perform a digital operation based on digital signals output by the plurality of stages respectively, each of the plurality of stages including: an A/D converter circuit configured to convert an analog input signal to a digital signal; a D/A converter circuit configured to reconvert the digital signal to an analog signal; and an arithmetic circuit configured to output a subtraction signal obtained by subtracting the analog signal output by the D/A converter from the analog input signal and amplify the subtraction signal,
the arithmetic circuit including:
an input terminal configured to receive an input signal;
a plurality of capacitors;
an amplifier circuit including an amplifying input terminal and an output terminal, and configured to amplify a signal input from the amplifying input terminal and output it as an output signal from the output terminal;
a first switch circuit configured to become conductive based on a first control signal to thereby connect the plurality of capacitors in parallel between the input terminal and a first voltage terminal for supplying a first voltage; and
a second switch circuit configured to become conductive based on a second control signal to thereby connect a first capacitor of the plurality of capacitors between the amplifying input terminal and a second voltage terminal for supplying a second voltage so as to form a first current path and connect a second capacitor of the plurality of capacitors between the amplifying input terminal and the output terminal so as to form a second current path.

15. The A/D converter according to claim 14,
wherein a plurality of capacitors are connected in series to at least one of the first current path and the second current path.

16. The A/D converter according to claim 14,
wherein the second voltage has a value obtained by multiplying a variable by a voltage value of a reference voltage.

17. The A/D converter according to claim 14, further comprising a third capacitor and a third switch circuit configured to become conductive based on the second control signal,
wherein the third switch circuit connects one end of the third capacitor to the amplifying input terminal and the other end thereof to a third voltage terminal for supplying a third voltage based on the second control signal.

18. The A/D converter according to claim 17,
wherein the first switch circuit connects the other end of the third capacitor to a fourth voltage terminal for supplying a fourth voltage based on the first control signal.

19. The A/D converter according to claim 17,
wherein the third capacitor is a variable capacitor.

20. The A/D converter according to claim 14, further comprising a plurality of fourth capacitors,
wherein the first switch circuit connects the plurality of fourth capacitors in parallel between a terminal for supplying a reference voltage and the first voltage terminal based on the first control signal, and
the second switch circuit connects the plurality of fourth capacitors in series based on the second control signal.
